(19) United States
(12) Patent Application Publication
(10) Pub. No.: US 2010/0307422 A1
(43) Pub. Date: Dec. 9, 2010

(54) WASTE COLLECTION MATS

(76) Inventors: Nathan Huck, Jackson, MI (US); Dorothy Meilinger, St. Louis, MO (US); Hyran Son, Clayton, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/311,841

(22) PCT Filed: Oct. 19, 2007
(86) PCT No.: PCT/US2007/022371

§ 371 Date: Apr. 15, 2009

Related U.S. Application Data
(60) Provisional application No. 60/853,146, filed on Oct. 20, 2006.

(51) Int. Cl. A01K 29/00; A61D 99/00; B65D 71/00; B32B 33/00

(52) U.S. Cl. 119/161; 119/171; 600/584; 206/223; 156/90

(57) ABSTRACT

Animal waste collections mats comprising a textured layer, an absorbent layer attached to the textured layer, and an impermeable layer attached to the absorbent layer. The textured layer of the waste collection mat can have one or more physical properties that animals find pleasing or acceptable. The absorbent layer acquires and stores moisture from the textured layer. The impermeable layer provides containment for the waste products in the textured and absorbent layers.

### CROSS REFERENCE TO RELATED APPLICATIONS

This application claims priority to U.S. Provisional Application Ser. No. 60/853,146 filed Oct. 20, 2006, and PCT/US2007/022371 filed Oct. 19, 2007, the disclosures of which is incorporated herein by this reference.

### BACKGROUND OF THE INVENTION

1. Field of the Invention

The invention relates generally to waste control technologies and particularly to animal waste collection mats.

2. Description of the Related Art

Animal waste collection products such as cat litter are commonly used to collect the waste of a pet such as a cat. The cat litter is poured into a cat litter box or tray and collects the cat's waste products. However, cat litter comprises numerous particulates that can be tracked and scattered by the cat as it moves in and out of the litter box. The used cat litter can also be dusty and have a high bulk density leading to difficult cleaning once the cat litter needs to be changed.

U.S. Pat. No. 5,819,688 discloses a pet animal odor absorbing mat comprising a mat or pad formed of a fibrous material, such as a cellulosic material, and zeolite integrally incorporated into the mat. U.S. Pat. Nos. 6,578,520 and 6,802,281 disclose an absorbent mat useful for treating pet excrete that utilizes plant fiber and pulp as a base material. U.S. Pat. No. 6,742,478 discloses an animal bedding material that includes a layer of substantially dry ground drywall and a layer of a substantially absorbent litter material. U.S. Pat. No. 6,976,451 discloses an animal waste collection pad having a backing sheet of fluid impervious material, one or more absorbent sheets overlying the backing sheet, a top sheet overlying the absorbent sheet(s), and an integrated tie means along one dimension of the collection pad. U.S. Pat. No. 5,630,377 discloses a pet toilet having a plurality of bundled disposable strips. These animal waste control products do not control particulates that can be tracked into the environment by the animal and are often difficult to clean. There is, therefore, a need for novel waste control products, particularly waste control mats, that substitute for conventional animal litters, control particulates and are easy to clean and maintain.

### SUMMARY OF THE INVENTION

It is, therefore, an object of the present invention to provide a waste collection mat that can a substitute for conventional cat litter.

It is another object of the invention to provide an animal waste collection mat useful for eliminating or controlling particulates.

It is a further object of the invention to provide a waste collection mat that is easy to clean and maintain.

It is another object of the invention to provide a waste collection mat that is adapted to fit and be removed from a litter box.

It is another object of the present invention to provide a waste collection mat that is acceptable for an animal to use.

Additional features and advantages are described herein, and will be apparent from, the following Detailed Description and the figures.

One or more of these and other objects are achieved using a novel waste collection mat comprising a textured layer comprising a plurality of filaments, an absorbent layer attached to the textured layer, and an impermeable layer attached to the absorbent layer. The filaments are used instead of conventional litter. They may cover and camouflage fecal material thus increasing consumer acceptance of the waste collection mat. There materials used for the mat result in few if any particulates to be tracked into the environment by the animal. The mat is easy to clean and fits easily into typical animal litter boxes.

Other and further objects, features, and advantages of the present invention will be readily apparent to those skilled in the art.

### BRIEF DESCRIPTION OF THE FIGURES

FIG. 1 illustrates a waste collection mat in one embodiment of the present invention.

FIG. 2 illustrates a waste collection mat in another embodiment of the present invention.

FIG. 3 illustrates a waste collection mat being removed from a box using a drawstring.

### DETAILED DESCRIPTION OF THE INVENTION

The present invention relates to waste collection mats useful for collecting and storing waste products and allowing for convenient disposal of the waste products. Generally, the waste collection mats are as acceptable for an animal as conventional litter, e.g. in terms of out-of-box and in-box waste removal. The invention provides waste collection mats and methods of making the waste collection mats. In an embodiment, the waste collection mat comprises a textured layer, an absorbent layer attached to the textured layer, and an impermeable layer attached to the absorbent layer. For example, the absorbed layer is attached to a side of the textured layer and the impermeable layer is attached to a side of the absorbent layer to form a composite layered waste collection mat.

In one embodiment, the textured layer comprises a plurality of filaments attached to a base. The plurality of filaments comprise a component such as, for example, a polymer, a plant material, and combinations thereof. In other embodiments, the filaments comprises a stem and a head or each of the filaments comprises a strand of a paper material. In further embodiments, the textured layer comprises a porous mat, preferably a porous rubber mat, or an absorbent attached to the textured layer. In other embodiments, the absorbent comprises a component such as clays, minerals, cellulosic materials, processed absorbents, and combinations thereof.

In a particular embodiment, the textured layer comprises one or more aromas, fragrances, odor masking agents, odor inhibitors, or combinations thereof In others, the absorbent layer comprises an absorbent polymer, a woven material, a non-woven material, and combinations thereof In one embodiment, the absorbent layer comprises a component such as clays, minerals, cellulosic materials, processed absorbents, and combinations thereof In an embodiment, the impermeable layer comprises a component such as polypropylene, polyethylene, polycarbonate, plastics, and combinations thereof In another, the impermeable layer comprises metal, wood, or glass.

In an embodiment, the waste collection mat further comprises a support attached to the impermeable layer. In one embodiment, the support is attached to the impermeable layer by a device such as velcro, sticky tape, buttons, zipper, magnet, and combinations thereof In an embodiment, the support is selected from the group consisting of a box, a tray, and combinations thereof.

In an embodiment, at least one of the layers comprises an odor control material. In another, the odor control material comprises activated carbon, silica, clay, active neutralizers, anti-microbials, and combinations thereof.

In various embodiments, at least one of the layers comprises an indicator. In an embodiment, the indicator detects one or more characteristics such as urinary tract disease, diabetes, glucose, blood, urine pH, renal function, pregnancy, and combinations thereof.

In an embodiment, the waste collection mat further comprises an enclosing mechanism selected from the group consisting of hook & loop, button, slot & tab, adhesive, drawstring, adhesive tab, and combinations thereof.

In another embodiment, the present invention provides a waste collection mat comprising: a textured layer, an absorbent layer comprising a moisture acquisition layer, a moisture distribution layer and a moisture storage layer, and an impermeable layer.

In still another embodiment, the present invention provides a waste collection mat comprising a textured layer containing textural features, an absorbent layer, and an impermeable layer. For example, textural features can comprise one or more raised ridges, treads, raised dimples, nubs, printed texture, raised dots, pockets of absorbent material, and combinations thereof.

In an alternative embodiment, the present invention provides a waste collection mat comprising a textured layer comprising plurality of filaments attached to the base, the plurality of filaments comprising an absorbent, an absorbent layer comprising a moisture acquisition layer, a moisture distribution layer and a moisture storage layer, and an impermeable layer.

In yet another embodiment, the present invention provides a method of making a waste collection mat. In one embodiment, the method comprises providing a textured layer comprising plurality of filaments attached to the base, attaching an absorbent layer to the base of the textured layer, and attaching an impermeable layer to the absorbent layer.

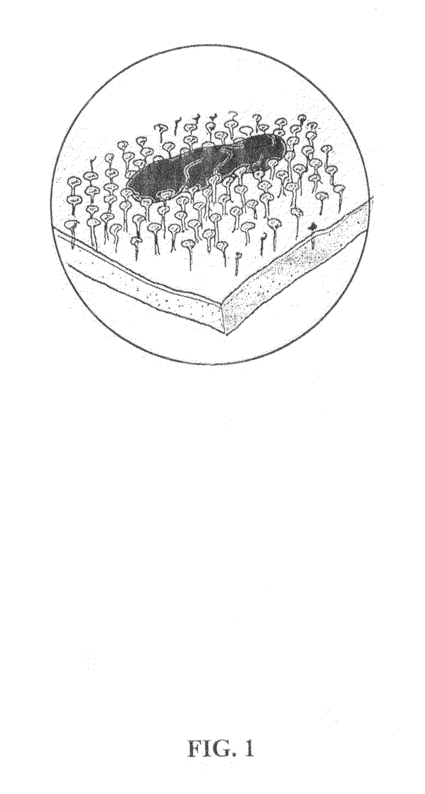

Referring to FIG. 1, in a general embodiment, the present invention provides a waste collection mat 10 comprising a textured layer 20, an absorbent layer 40 attached to a side of the textured layer 20, and an impermeable layer 50 attached to a side of the absorbent layer 40. The textured layer 20 of the waste collection mat 10 can have one or more physical properties that animals (e.g. cats) find pleasing or acceptable in a non-litter waste elimination substrate. These properties may include an animal acceptable texture and aroma. Each of the layers can be attached to the adjacent layer by any suitable means such as, for example, adhesives, fasteners, etc.

The textured layer 20 can have characteristics similar to that of artificial turf. In the embodiment shown in FIG. 1, the textured layer 20 comprises a plurality of filaments 22 attached to a base 24. Alternatively, the filaments 22 can be attached directly to the absorbent layer 40. The filaments 22 and/or base 24 can be made of any suitable materials such as, for example, polymers, plant materials (e.g. cellulose, fiber), and combinations thereof. The filaments 22 can be any suitable size, shape and length. For example, in the embodiment shown in FIG. 1, each of the filaments 22 comprises a stem 26 and a head 28 (e.g. an enlarged end).

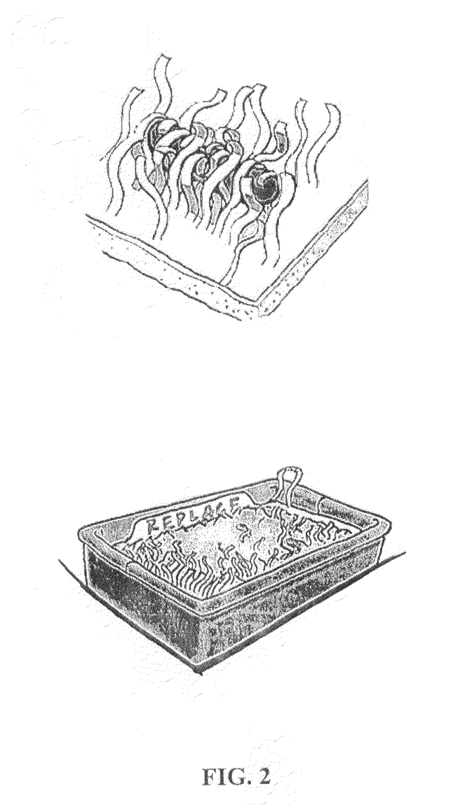

In an alternative embodiment shown in FIG. 2, the present invention provides a waste collection mat 110 comprising a textured layer 120, an absorbent layer 140 attached to a side of the textured layer 120, and an impermeable layer 150 attached to a side of the absorbent layer 140. In this embodiment, each of the filaments 122 comprises a wavy strand 126 made of a suitable material such as, for example, a shredded paper or fiber material.

The textured layer (e.g. having filaments or strands) may impart acceptance by an animal, for example, as a result of it simulating or satisfying the waste product covering behavior of the particular animal. For example, the filaments 22 and 122 may be of sufficient length to allow an animal the sensation of digging and covering its waste post elimination.

The textured layer may also aid or serve to cover and/or disguise objectionable/unsightly waste material from the consumer. For example, longer filaments may cover and camouflage fecal material 170 from observers of the waste collection mat (FIG. 2), thereby increasing consumer acceptance of the waste collection mat after it has been used.

In alternative embodiments, the textured layer 20 and/or components of the textured layer such as the filaments 22 can include hydrophilic elements to promote dehydration of fecal and/or hydrophobic elements and aid in driving moisture into the absorbent layer and maintaining it there. Non-limiting examples of hydrophobic elements include polysiloxanes, (e.g. trimethyl-hydroxysilane), waxes and/or various oils.

In alternative embodiments, the textured layer may be arranged in a variety of configurations. These embodiments can include filaments/fibers attached to a base or absorbent layer on one end with absorbent/nonabsorbent particles attached to the opposing end, a plurality of different textures resulting from incorporating several different types/configurations for the surface of the textured layer (e.g. patterns, niches, grooves), textural elements covering part or all of the textured layer surface or arranged in patterns such that portions of the textured layer are bare, veneers of granular, fibrous or other absorbent material (e.g. absorbent litter material attached by adhesion or other means directly to an absorbent pad).

In alternative embodiments, the textured layer can comprise any suitable textural feature in addition to or in place of the filaments. For example, the textural features can comprise one or more raised ridges (e.g. treads), raised dimples or nubs (e.g. small lumps or protuberances), and combinations thereof. The textured layer can comprise printed/or otherwise applied texture such as raised dots. The dot materials can be absorbent/non-absorbent. The dot materials can contain odor control additives including activated carbon. The textural features can also be one or more nubs made from rubber/silicone or other suitable materials and one or more pockets of granular or absorbent materials.

In alternative embodiments, the textured layer and/or filaments can incorporate anywhere additional elements such as, for example, absorbents, odor control, fragrance, anti-microbials, attractants, indicators, and combinations thereof For example, the textured layer and/or filaments can comprise any suitable odor neutralizing components. The textured layer and/or filaments may also comprise an animal attractive/acceptable aroma.

In addition, the textured layer and/or filaments can comprise a waste elimination marker. For example, there may be identifiable compounds found in animal waste that are “marker” compounds for “marking” a particular location for elimination. It is these types of compounds that would chemically communicate the intended use of the mat to the cat/animal.

Non-limiting examples of materials that can be used for the textured layer 20 include paper, synthetic turf, polyethylene, polypropylene, polystyrene, nonwoven materials, naturally occurring fibrous plant material, jute fiber, coco moss, cotton, cellulosic materials, recycled materials, rubber, and combinations thereof.

The absorbent layer 40 can acquire and store liquid waste from the textured layer. In alternative embodiments, the absorbent layer can comprise one or more suitable layers such as, for example, an acquisition layer, a distribution layer and a storage layer. The acquisition layer can pull moisture from textured layer and act as a one-way membrane that prevents moisture from seeping back out when animal waste mat is stepped on or disposed of. The distribution layer can facilitate spreading moisture throughout this layer so that it is presented evenly to a containment core beneath it. The storage layer can be highly absorbent and may comprise super-absorbent polymers.

In alternative embodiments, the absorbent layer can comprise one or more woven and/or non-woven materials suitable for absorbing, collecting and/or maintaining a waste product. The absorbent layer can also comprise malodor control elements.

In alternative embodiments, nonwoven materials may be used in both the absorbent layer(s) and even as elements of the textured layer. These materials are well known in the hygiene arts and are found in a wide variety of consumer products including wipes, diapers, adult hygiene products, automotive fabrics, sound insulation, construction materials, moisture barriers. Non-limiting examples of nonwoven materials/fabrics may be derived from various processes including air-laid, wet-laid, spun-bound, spun-laced and hydroentangled. The nonwoven materials/fabrics may be derived from natural or synthetic materials including, for example, polyethylene, polypropylene, polyvinyl chloride, or plant derived fibers/materials including cotton, jute and coco moss. Fibers used in production can be monofilament or a blend of different materials (bicomponent).

In place of or in addition to nonwoven elements, the absorbent layer(s) may contain paper, cardboard, recycled paper materials, cellulosic materials and absorbents/absorbent materials.

In alternative embodiments, one or more absorbents or absorbent materials can be used in portions of the absorbent layer of the waste collection mat and/or included in portions of the textured layer/impermeable layer. For example, the absorbents or absorbent materials can be clays, minerals, cellulosic materials, processed absorbent materials, and combinations thereof.

Non-limiting examples of clay and other absorbent minerals (e.g. includes swelling and non-swelling clays/minerals) that can be used in the textured and/or the absorbent layers include montmorillonites (e.g. sodium, calcium), vermiculite, smectite, hectorite, sepiolite, zeolite, silicate, Georgia white clay, calcite, dolomite, slate, pumice, bentonite, diatomaceous earth, Fuller's earth, attapulgite, vermiculite, phallysite, kaolinite, perlite, gypsum, calcium oxide, calcium chloride and calcium sulfate (including in expanded forms of the clays/minerals). It should be appreciated that the absorbents/absorbent materials can be any suitable size and shape to be incorporated into the layers of the waste collection mat.

Non-limiting examples of naturally occurring cellulosic materials include recycled materials, paper, wood, straw, organic fiber, coco moss, peat moss, jute, plant hulls, alfalfa, bark, sawdust, peelings, chips, strands, pulp, corn and wheat.

Non-limiting examples of processed absorbent materials include silica gel, activated carbon, super absorbent polymers (SAPs) including polyacrylates, polyacrylamides, potassium acrylate starches, polysaccharides, carrageenans, guar gum and soy based absorbents.

In alternative embodiments, any of the layers of the waste collection mat may comprise one or more aromas, fragrances and/or odor masking agents/odor inhibitors. The fragrances may further be refined such that they releases more strongly under certain conditions. For example, initiation of this release may be the result of moisture change, temperature, and/or friction. Additionally, fragrances may be delivered in a manner described in U.S. Pat. No. 6,803,033 and U.S. Pat. No. 5,267,531. Fragrances may be encapsulated or incorporated into wax and applied to any of the layers.

Non-limiting examples of odor control agents/odor inhibitors include chlorinated oxidizers (e.g. chlorine dioxide), aldehydes, permanganates, peroxides, metal oxides, borates, borax, perborates, enzymes, urease inhibitors, proteases, cationic surfactants (e.g. N-ethyl-N-soyamorpholiniumethosulphate), metallic salts including zinc salts, zinc ricinoleate, zinc chloride, zinc gluconate, metal ions including transition metal ions, nano-particulate metal ions including ferric and aluminum salts, silver, copper, zinc, carbon (e.g. activated), oxides, cyclodextrins, zeoloites, activated carbon, activated alumina, calcium carbonate, silicas, clay minerals, chlorophyll, metal organic frameworks (MOFs), molecular sieves, chelating agents and metal binders such as EDTA.

In alternative embodiments, any of the layers of the waste collection mat may comprise one or more anti-microbials. Odor may develop from the microbial metabolic by-products resulting from growth of microorganisms in the animal waste environment. By limiting or preventing this growth, this potential source of odor is reduced/eliminated. Control of pathogenic bacteria in this environment may also address both consumer and animal health issues. Potentially pathogenic and zoonotic microbes include bacteria, nematodes, fungi, and protozoa such as Campylobacter spp., Jejuni, Salmonella spp., Escherichia coli, Yersinia enterocolitica, Uncinaria stenocephala, Ancylostoma braziliense, Toxocara cati, Toxascaris leonina, Toxoplasma condii, Entamoeba histolytica, Cryptosporidium parvum, Giardia spp. and Pentatrichomonas hominis.

Non-limiting examples of anti-microbials (can also be used as odor control agents) include myacide (bronopol), bromine containing compounds, borax and other boron containing compounds, povidone iodide, quaternary amines, metal ions including silver, bacteriophages, short chain alkyl esters of p-hydroxybenzoic acid commonly known as parabens, halogenated aromatic hydrocarbons, organic sulfur compounds, chlorhexidine. Additional anti-microbials are listed in U.S. Pat. No. 6,287,550.

In alternative embodiments, any of the layers of the waste collection mat may comprise one or more animal attractants. For example, an attractant may increase animal acceptance of the waste collection mat. Attractant sources may be plant extracts or material (herbal or otherwise), pheromonal, or other metabolic marker compounds in urine/fecal matter.

Non-limiting examples of marker compounds include 3-methyl-2-buten-1-ol, 3-mercapto-3-methyl-1-butanol, α-valerolactam (Likely to be an anal sac secretion), pyrazine, methyl pyrazine, 2,6-dimethylpyrazine, phenol, trimethylpyrazine, dimethylsulfone, indole, 1-methylhydantoin and phenylacetamide.

The following are non-limiting examples of plants that attract animals such as cats and therefore can contain compounds that could be used to create a animal attractant: catnip (nepeta cataria—active ingredient: nepetalactone), valerian (valeriana officinalis—active ingredient: actinidine), cat thyme (teucrium marum), silver vine (actinidia polygama—active ingredient(s): actinidine, dihydroactinidiolide), buckbean (menyanthes trifoliata—active ingredient: boschniakine), yellowbells (tecoma stans—active ingredient(s): boschniakine, actinidine), trumpet creeper (campsis radicans), squawroot, beechdrops, cranberry bush, dittany of crete, baby blue-eyes, lippia javanica, nepeta nepitella, matabi and honeysuckle.

In alternative embodiments, any of the layers of the waste collection mat may comprise one or more indicators or diagnostic components. As shown in FIGS. 1 and 2, one or more color change indicators 80 and 180, respectively, may be incorporated into the waste collection mat to signal a variety of conditions including when the mat is full/ready for replacement and/or detect/diagnose an animal's health conditions. For example, the health conditions can include urinary tract disease, diabetes, glucose, blood, urine pH, renal function, pregnancy. Such indicators/diagnostic components may rely on a simple pH dependant color change or may incorporate highly specialized techniques (e.g. enzyme-linked immunosorbent assay (ELISA)) to detect/monitor specific elements/compounds or test for specific diseases present in the animal waste material.

Non-limiting examples of pH dependant indicators include methyl violet, eosin yellow, malachite green, thymol blue, methyl yellow, bromophenol blue, congo red, methyl orange, methyl orange, bromocresol green, methyl red, litmus, bromocresol purple, bromophenol red, bromothymol blue, phenol red, neutral red, naphtholphthalein, thymol blue, phenolphthalein, thymolphthalein, alkali blue, alizarin yellow, indigo carmine and epsilon blue.

The impermeable layer 50 can provide containment for the waste products in the textured and absorbent layers. The impermeable layer 50 can comprise any suitable impermeable materials such as, for example, polypropylene, polyethylene, polycarbonate, plastics, and combinations thereof. In an alternative embodiment, the impermeable layer 50 can comprise non-skid elements or pads to prevent the impermeable layer 50 from sliding or moving along a floor.

In various embodiments, the waste collection mat (e.g. each layer therein) of the present invention can be any suitable size, shape, height, length and width. For example, as shown in FIG. 2, the waste collection mat 110 can be a size that suitably fits within a support 160 such as a box or tray. The waste collection mat may be used in traditional litter boxes or a specialized holder. This specialized holder may take the form of a litter box, tray or even a simple frame. The support 160 can be attached to the impermeable layer 150 by any suitable attachment device such as, for example, velcro, sticky tape, buttons, zipper, magnet, and combinations thereof.

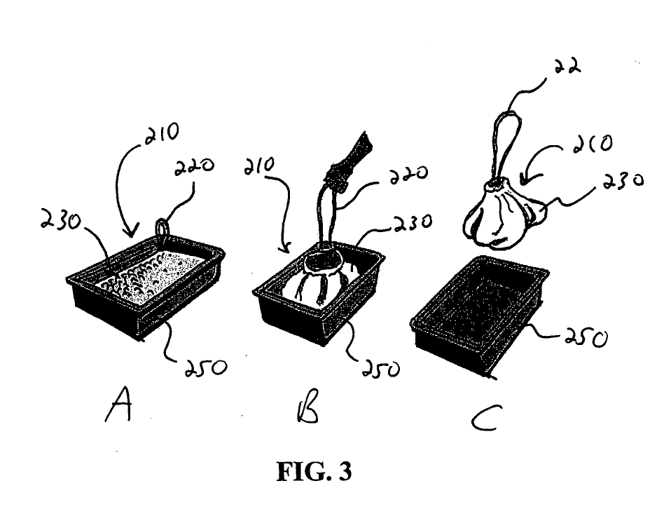

The waste collection mat can be disposable and have elements that facilitate ease of disposal. As shown in FIG. 3, in an alternative embodiment, the waste collection mat 210 can comprise a drawstring or strap 220 attached to the impermeable layer 230 for cinching or closing the waste collection mat. For example, when the waste collection mat 210 is ready to be disposed of, a user grabs the drawstring 220 and pulls (FIG. 3B). This allows the impermeable layer 230 to form the outer layer of the waste collection mat 210 so that its contents can be enclosed (FIG. 3C) while the waste collection mat 210 is removed from the support 250. The entire waste collection mat 210 can then be easily disposed of.

In alternative embodiments, the waste collection mat can have any suitable enclosing mechanisms such as, for example, hook & loop, button, slot & tab, adhesive, drawstring, adhesive, tab, and combinations thereof for closing/sealing the waste collection mat. The enclosing mechanisms may be attached to or be incorporated in any of the layers of the waste collection mat.

If the pet is used to conventional litter, the consumer may need to transition using the waste collection mat gradually by adding successively smaller amounts of their current granular/particulate waste collection material to the surface of the waste collection mat. Eventually a point can be reached where no additional granular/particulate material is needed to be added to accommodate animal acceptance of the waste collection mat.

If so desired, the consumer can remove solid waste from the textured layer of the waste collection mat at any interval they determine appropriate, for example, before, during and after the liquid waste is absorbed into the absorbent layer.

Replacement mats can be conveniently dispensed on a roll, or perhaps be arranged vertically in a stack stored in a dedicated hardware unit. For example, the replacement waste collection mat may be located beneath the mat that is currently being used such that, when the currently used mat becomes soiled and is peeled away or otherwise disposed of, the new mat is revealed.

In one aspect, the present invention provides a device comprising a tray suitable for containing the waste collection mat of the present invention and a waste collection mat of the present invention placed in the tray. In one embodiment, the tray is identical to or similar to the tray shown in FIG. 2. The tray can, however, be designed to be more ergonomically suitable by an animal. For example, the tray can have an opening the facilitates animal entry and exit from the tray.

In another aspect, the present invention provides a device comprising a housing suitable for containing the waste collection mat or the tray containing the waste collection mat placed inside the housing. In one embodiment, the device is a pet litter box, e.g., and easy access litter box such as that shown in US20070084413A1.

In a further aspect, the present invention provides kits suitable for managing animal waste, e.g., urine and feces. The kits comprise in separate containers in a single package or in separate containers in a virtual package, as appropriate for the kit component, a waste collection mat comprising a textured layer comprising a plurality of filaments; an absorbent layer attached to the textured layer; and an impermeable layer attached to the absorbent layer and one or more of (1) aromas, fragrances, or other materials useful for controlling animal waste odor, e.g., compounds and materials useful for masking odors, inhibiting odor formation, or absorbing odors, e.g., activated carbon useful for absorbing odors from urine or feces, perfumes that mask odors, desiccants that absorb or otherwise control moisture and inhibit odor formation, and the like; (2) devices and materials useful for removing animal waste from the waste collection mat or from litter and litter boxes, e.g., scoops, rakes, pads, litter, gloves, and the like; (3) devices and materials useful for cleaning the waste collection mat, e.g., soaps, detergents, cloths, brushes, and the like; (4) instructions for how to use the waste collection mat, alone or in combination with aromas, fragrances, and/or materials useful for controlling animal waste odor, devices useful for removing animal waste from the waste collection mat, and devices and materials useful for cleaning the waste collection mat; (5) food compositions suitable for consumption by an animal; (6) dietary supplements and other materials useful for promoting the health of an animal, e.g., vitamins, minerals, probiotics, and the like; and (7) urine or fecal diagnostic devices useful for testing animal urine and/or fecal matter for the presence of compounds or materials indicative of the health of the animal, e.g., urine test strips such as those disclosed in U.S. Pat. No. 6,805,838 and U.S. Pat. No. 6,001,658 and the indicators and diagnostic components discussed herein.

As used herein, the term “single package” means that the components of a kit are physically associated in or with one or more containers and considered a unit for manufacture, distribution, sale, or use. Containers include, but are not limited to, bags, boxes, bottles, shrink wrap packages, stapled or otherwise affixed components, or combinations thereof. A single package may be containers of individual fragrances, materials, and devices useful for cleaning a litter collecting apparatus such as a litter box or waste collection mat, devices for removing litter from a litter collecting apparatus such as a litter box or waste collection mat physically associated such that they are considered a unit for manufacture, distribution, sale, or use. The term “virtual package” means that the components of a kit are associated by directions on one or more physical or virtual kit components instructing the user how to obtain the other components, e.g., in a bag containing one component and directions instructing the user to go to a website, contact a recorded message, view a visual message, or contact a caregiver or instructor to obtain instructions on how to use the kit.

When the kit comprises a virtual package, the kit is limited to instructions in a virtual environment in combination with one or more physical kit components. Generally, the kit contains a waste collection mat and one or more other components as described herein. The kits may contain the kit components in any of various combinations. In one embodiment, the kit contains a waste collection mat and a container of aroma and/or fragrance suitable for controlling odor from animal waste.

In another aspect, the present invention provides a means for communicating information about or instructions for one or more of (1) using the waste collection mat of the present invention to control animal waste; (2) using the waste collection mat in combination with aromas, fragrances, or other materials useful for controlling animal waste odor; (3) using the waste collection mat in combination with devices and materials useful for removing animal waste from the waste collection mat; (4) using the waste collection mat in combination with devices and materials useful for cleaning the waste collection mat; (5) cleaning the waste collection mat; (6) using the waste collection mat in combination with urine or fecal diagnostic devices useful for testing animal urine and/or fecal matter for the presence of compounds or materials indicative of the health of the animal; (7) disposing of the waste collection mat after use; (8) using the waste collection mat in combination with trays or other devices suitable for holding the mat; and (9) using the waste collection mat in combination with litter boxes, with or without trays. The means comprises a document, digital storage media, optical storage media, audio presentation, or visual display containing the information or instructions. In certain embodiments, the communication means is a displayed web site, visual display kiosk, brochure, product label, package insert, visual display, advertisement, handout, public announcement, audiotape, videotape, DVD, CD-ROM, computer readable chip, computer readable card, computer readable disk, computer memory, or combination thereof containing such information or instructions. Useful information includes one or more of (1) methods and techniques for training an animal to adjust to and use the waste collection mat and (2) contact information for animal caregivers to use if they have a question about the waste collection mat and its use. Useful instructions include training techniques, training timelines, cleaning methods, disposal methods, and the like. Useful instructions include training techniques, training timelines, cleaning methods, disposal methods, and the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, is relevant prior art for the present invention and the right to challenge the accuracy and pertinence of such patents, patent applications, publications, and other references is specifically reserved.

What is claimed is:

1. A waste collection mat comprising:
a textured layer comprising a plurality of filaments;
an absorbent layer attached to the textured layer; and
an impermeable layer attached to the absorbent layer.

2. The waste collection mat of claim 1 wherein the plurality of filaments are attached to a base, the plurality of filaments comprising a component selected from the group consisting of a polymer, a plant material, and combinations thereof.

3. The waste collection mat of claim 1 wherein each of the filaments comprises a stem and a head.

4. The waste collection mat of claim 1 wherein each of the filaments comprises a strand of a cellulosic material.

5. The waste collection mat of claim 1 wherein the textured layer comprises a porous mat.

6. The waste collection mat of claim 1 wherein the textured layer comprises an absorbent attached to the textured layer.

7. The waste collection mat of claim 6 wherein the absorbent comprises a component selected from the group consisting of clays, minerals, cellulosic materials, processed absorbents, and combinations thereof.

8. The waste collection mat of claim 1 wherein at least one of the layers comprises a component selected from the group consisting of aromas, fragrances, odor masking agents, odor inhibitors, and combinations thereof.

9. The waste collection mat of claim 1 wherein the absorbent layer is selected from the group consisting of a woven material, a non-woven material, and combinations thereof, the absorbent layer comprising an absorbent polymer.

10. The waste collection mat of claim 1 wherein the absorbent layer comprises a component selected from the group consisting of clays, minerals, cellulosic materials, processed absorbents, and combinations thereof.

11. The waste collection mat of claim 1 wherein the impermeable layer comprises a component selected from the group consisting polypropylene, polyethylene, polycarbonate, plastics, and combinations thereof.

12. The waste collection mat of claim 1 wherein the impermeable layer comprises a non-skid element.

13. The waste collection mat of claim 1 further comprising a support attached to the impermeable layer.

14. The waste collection mater of claim 13 wherein the support is attached to the impermeable layer by a device selected from the group consisting of velcro, sticky tape, buttons, zipper, magnet, and combinations thereof.

15. The waste collection mat of claim 13 wherein the support is selected from the group consisting of a box, a tray, and combinations thereof

16. The waste collection mat of claim 1 wherein at least one of the layers comprises an odor control material.

17. The waste collection mat of claim 16 wherein the odor control material is selected from the group consisting of activated carbon, silica, clay, active neutralizers, anti-microbials, and combinations thereof

18. The waste collection mat of claim 1 wherein at least one of the layers comprises an indicator.

19. The waste collection mat of claim 18 wherein the indicator detects a characteristic selected from the group consisting of urinary tract disease, diabetes, glucose, blood, urine pH, renal function, pregnancy, and combinations thereof.

20. The waste collection mat of claim 1 further comprising an enclosing mechanism selected from the group consisting of hook & loop, button, slot & tab, adhesive, drawstring, adhesive tab, and combinations thereof

21. A waste collection mat comprising:
a textured layer;
an absorbent layer attached to the textured layer, the absorbent layer comprising a moisture acquisition layer, a moisture distribution layer and a moisture storage layer; and
an impermeable layer attached to the absorbent layer.

22. A waste collection mat comprising:
a textured layer, the textured layer comprising textural features selected from the group consisting of raised ridges, treads, raised dimples, nubs, printed texture, raised dots, pockets of absorbent material, and combinations thereof;
an absorbent layer attached to the textured layer, the absorbent layer comprising a moisture acquisition layer, a moisture distribution layer and a moisture storage layer; and
an impermeable layer attached to the absorbent layer.

23. A waste collection mat comprising:
a textured layer comprising plurality of filaments attached to the base, the plurality of filaments comprising an absorbent;
an absorbent layer attached to the textured layer, the absorbent layer comprising a moisture acquisition layer, a moisture distribution layer and a moisture storage layer; and
an impermeable layer attached to the absorbent layer.

24. A method of making a waste collection mat comprising:
providing a textured layer comprising plurality of filaments attached to the base;
attaching an absorbent layer to the base of the textured layer; and
attaching an impermeable layer to the absorbent layer.

25. A kit suitable for managing animal waste comprising in separate containers in a single package or in separate containers in a virtual package, as appropriate for the kit component, a waste collection mat comprising a textured layer comprising a plurality of filaments; an absorbent layer attached to the textured layer; and an impermeable layer attached to the absorbent layer and one or more of (1) aromas, fragrances, or other materials useful for controlling animal waste odor; (2) devices and materials useful for removing animal waste from the waste collection mat or from litter and litter boxes; (3) devices and materials useful for cleaning the waste collection mat; (4) instructions for how to use the waste collection mat, alone or in combination with aromas, fragrances, and/or materials useful for controlling animal waste odor, devices useful for removing animal waste from the waste collection mat, and devices and materials useful for cleaning the waste collection mat; (5) food compositions suitable for consumption by an animal; (6) dietary supplements and other materials useful for promoting the health of an animal; and (7) urine or fecal diagnostic devices useful for testing animal urine and/or fecal matter for the presence of compounds or materials indicative of the health of the animal.

26. A means for communicating information about or instructions for one or more of (1) using the waste collection mat of the present invention to control animal waste; (2) using the waste collection mat in combination with aromas, fragrances, or other materials useful for controlling animal waste odor; (3) using the waste collection mat in combination with devices and materials useful for removing animal waste from the waste collection mat; (4) using the waste collection mat in combination with devices and materials useful for cleaning the waste collection mat; (5) cleaning the waste collection mat; (6) using the waste collection mat in combination with urine or fecal diagnostic devices useful for testing animal urine and/or fecal matter for the presence of compounds or materials indicative of the health of the animal; (7) disposing of the waste collection mat after use; (8) using the waste collection mat in combination with trays or other devices suitable for holding the mat; and (9) using the waste collection mat in combination with litter boxes, with or without trays comprising a document, digital storage media, optical storage media, audio presentation, or visual display containing the information or instructions. In certain embodiments, the communication means is a displayed web site, visual display kiosk, brochure, product label, package insert, visual display, advertisement, handout, public announcement, audiotape, videotape, DVD, CD-ROM, computer readable chip, computer readable card, computer readable disk, computer memory, or combination thereof containing such information or instructions.

27. The means of claim 26 selected from the group consisting of a displayed web site, visual display kiosk, brochure, product label, package insert, visual display, advertisement, handout, public announcement, audiotape, videotape, DVD, CD-ROM, computer readable chip, computer readable card, computer readable disk, computer memory, or combination thereof.
